(19) United States
(12) Patent Application Publication
(10) Pub. No.: US 2016/0321709 A1
(43) Pub. Date: Nov. 3, 2016

(54) DISTRIBUTED SYSTEM FOR PROCESSING OF TRANSACTION DATA FROM A PLURALITY OF GAS STATIONS

(71) Applicant: Gilbarco Inc., Greensboro, NC (US)

(72) Inventor: Tal Reichert, Medford, MA (US)

(21) Appl. No.: 15/210,310

(22) Filed: Jul. 14, 2016

Related U.S. Application Data
(63) Continuation of application No. 14/230,081, filed on Mar. 31, 2014.

(51) Int. Cl. G06Q 30/02

(52) U.S. Cl. CPC G06Q 30/0276; G06Q 30/0268

(57) ABSTRACT

Disclosed are methods, systems, and other implementations, including a method that includes receiving information from a plurality of retail points, with the information including transaction data for a plurality of transactions at one or more of the plurality of retail points and respective local retail data for each of the plurality of retail points. The method further includes determining for a retail point, from the plurality of the retail points, a set of promotion rules based on the transaction data and on the respective local retail data, and communicating the set to the retail point. When the set of promotion rules is applied to subsequent transaction data obtained at the retail point, a resultant promotion is generated in response to application of the set of promotion rules to one or more of the subsequent transaction data and/or to subsequent local retail data obtained at retail point.

### CROSS REFERENCE TO RELATED APPLICATION

This application claims priority to and is a continuation of U.S. patent application Ser. No. 14/230,081, entitled “Distributed Processing of Transaction Data,” filed Mar. 31, 2014, which is incorporated by reference herein in its entirety.

### BACKGROUND

Commercial entities devote considerable resources to marketing and promotion of their businesses. To achieve their marketing objectives, the commercial entities try to implement marketing strategies that enable them to individually target customers in a manner that would entice the customers to respond to the commercial entities' marketing efforts. The window of opportunity during which a commercial entity′ can target a customer attempting to complete a transaction is generally short, thus requiring marketing efforts to be delivered quickly.

### SUMMARY

In some variations, a method is disclosed that includes receiving, at a central computing system, information from a plurality of retail points that each includes at least one local computing device to facilitate transactions at the respective one of the plurality of retail points, the received information including transaction data for a plurality of transactions at one or more of the plurality of retail points and respective local retail data for each of the plurality′ of retail points. The method further includes determining, at the central computing system, for at least one of the plurality of the retail points a corresponding set of promotion rules based on the transaction data and on the respective local retail data for the each of the plurality of retail points, and communicating to the at least one of the plurality of retail points the corresponding set of promotion rules. When the corresponding set of promotion rules, communicated to the at least one of the plurality of retail points, is applied to subsequent transaction data obtained at the at least one of the plurality of retail points, a resultant promotion is generated in response to application of the corresponding set of promotion rules to one or more of, for example, the subsequent transaction data, and/or to subsequent local retail data obtained at the at least one of the plurality of retail points.

Embodiments of the method may include at least some of the features described in the present disclosure, including one or more of the following features.

The resultant promotion may include at least one second item to be presented to a customer at the at least one of the plurality of retail points in response to applying the corresponding set of promotion rules to one or more of, for example, the subsequent transaction data, which may include information representative of at least one first item selected by the customer from a plurality of purchasable items available at the at least one of the plurality of retail points, and/or the subsequent local retail data obtained at the at least one of the plurality of retail points.

The subsequent cal retail data for the at least one of the plurality of retail points may include one or more of, for example, geographic location of the at least one of the plurality of retail points, time information, date information, the plurality of purchasable items available at the at least one of the plurality of retail points, average time between transactions completed at the at least one of the plurality of retail points, and/or weather information at the at least one of the plurality of retail points.

The subsequent transaction data may include one or more of, for example, identity of the at least one first item selected by the customer, price of the at least one item selected by the customer, computed average and standard deviation for the price of the at least one items selected by the customer, and/or time at which the at least one first item was selected by the customer.

Determining for the at least one of the plurality of the retail points the corresponding set of promotion rules may include determining, for the at least one of the plurality of retail points, based on the transaction data and on the respective local retail data for the each of the plurality of retail points, possible promotions presentable at the at least one of the plurality of retails points and respective associated likelihoods of customer acceptance for each of the possible promotions presentable at the at least one of the plurality of retail points, and generating the corresponding set of promotion rules based, at least in part, on the determined likelihoods of customer acceptance associated with the respective possible promotions presentable at the at least one of the plurality of retail points.

Generating the corresponding set of promotion rules based, at least in part, on the determined likelihoods of customer acceptance associated with the respective possible promotions may include generating the corresponding set of promotional rules based on one or more metrics derived based on the determined likelihoods. The one or more metrics may include, for example, expected revenue, and/or expected margin.

Determining the possible promotions and the respective associated likelihoods of customer acceptance for each of the possible promotions may include determining, for each of the possible promotions, at least one second item to be presented to a customer at the at least one of the plurality of retail points in combination with at least one first item, selected by the customer from a plurality of purchasable items available at the at least one of the plurality of retail points, based, at least in part, on effectiveness measures that are each associated with at least one combination from a set of combinations that each includes the at least one first item to be purchased and a corresponding offer of cross-sale of at least one other item from the plurality of purchasable items available at the at least one of the plurality of retail points. Each of the effectiveness measures may be representative of a likelihood that the at least one other item to be offered to the customer would be accepted when offered in combination with the at least one first item being purchased, and may be computed based on p=s/N, where p represents the likelihood of the cross sale of the respective at least one other item when offered in combination with the respective at least one first item, s represents a number of successful cross sales over a period of time for the respective at least one other item when offered in combination with the respective at least one first item, and N is the number of times a cross-sale promotion offering the respective at least one other item in combination with the respective at least one first item has been presented over the period of time.

Determining the possible promotions presentable at the at least one of the plurality of retail points and the respective associated likelihoods of customer acceptance for each of the possible promotions may include deriving the associated likelihoods of customer acceptance for each of the possible promotions based on a statistical model implemented using one or more machine-learning processes applied to the transaction data for the plurality of transactions at the one or more of the plurality of retail points and the respective local retail data for each of the plurality of retail points.

Deriving the associated likelihoods of customer acceptance for each of the possible promotions based on the statistical model generated using the one or more machine-learning processes may include deriving the associated likelihoods based on the statistical model generated using a support vector machine process used in conjunction with a k-nearest neighbors process applied to the transaction data for the plurality of transactions at the one or more of the plurality of retail points and the respective local retail data for each of the plurality of retail points.

The one or more machine learning processes may include one or more of, for example, a support vector machine, a k-nearest neighbor procedure, a decision tree procedure, a random forest procedure, an artificial neural network procedure, a tensor density procedure, a regression technique, and/or a hidden Markov model procedure.

The method may further include receiving from the at least one of the plurality of retail points data representative of outcomes, over a pre-determined period of time, associated with promotions presented at the at least one of the plurality of retail points.

Communicating the respective corresponding set of promotion rules may include communicating a plurality of sets of promotional rules to the at least one of the plurality of retail points, wherein each of the plurality of sets of promotional rules is associated with a respective time period during which the associated one of the plurality of sets of promotional rules is applied at the at least one of the plurality of retail points.

In some variations, a server is disclosed that includes one or more processor-based devices, and one or more memory storage devices to store instructions. The instruction, when executed on the one or more processor-based devices, cause operations including receiving, at the server, information from a plurality of retail points that each includes at least one local computing device to facilitate transactions at the respective one of the plurality of retail points, the received information including transaction data for a plurality of transactions at one or more of the plurality of retail points and respective local retail data for each of the plurality of retail points. The instructions cause further operations including determining, at the server, for at least one of the plurality of the retail points a corresponding set of promotion rules based on the transaction data and on the respective local retail data for the each of the plurality of retail points, and communicating to the at least one of the plurality of retail points the corresponding set of promotion rules. When the corresponding set of promotion rules, communicated to the at least one of the plurality of retail points, is applied to subsequent transaction data obtained at the at least one of the plurality of retail points, a resultant promotion is generated in response to application of the corresponding set of promotion rules to one or more of, for example, the subsequent transaction data, and/or to subsequent local retail data obtained at the at least one of the plurality of retail points.

Embodiments of the server may include at least some of the features described in the present disclosure, including at least some of the features described above in relation to the method.

In some variations, a non-transitory computer readable media is provided that is programmed with instructions executable on at least one processor of a central computing system. The instructions, when executed, cause operations including receiving, at the central computing system, information from a plurality of retail points that each includes at least one local computing device to facilitate transactions at the respective one of the plurality of retail points, the received information including transaction data for a plurality of transactions at one or more of the plurality of retail points and respective local retail data for each of the plurality of retail points. The instruction cause further operations including determining, at the central computing system, for at least one of the plurality of the retail points a corresponding not of promotion rules based on the transaction data and on the respective local retail data for the each of the plurality of retail points, and communicating to the at least one of the plurality of retail points the corresponding set of promotion rules. When the corresponding set of promotion rules, communicated to the at least one of the plurality of retail points, is applied to subsequent transaction data obtained at the at least one of the plurality of retail points, a resultant promotion is generated in response to application of the corresponding set of promotion rules to one or more of for example, the subsequent transaction data, and/or to subsequent local retail data obtained at the at least one of the plurality of retail points.

Embodiments of the computer readable media may include at least some of the features described in the present disclosure, including at least some of the features described above in relation to the method and/or the server.

In some variations, a system is provided that includes a plurality of distributed processor-based devices deployed at a plurality of retail points, and a central server in communication with the plurality of distributed processor-based devices, the central server comprising at least one programmable device and one or more memory storage devices to store instructions. The instructions, when executed on the programmable device cause operations including receiving, at the central server, information from the plurality of processor-based devices that each facilitates transactions at respective ones of the plurality of retail points, the received information including transaction data for a plurality of transactions at one or more of the plurality of retail points and respective local retail data for each of the plurality of retail points. The instructions cause further operations including determining, at the central server, for at least one of the plurality of the retail points a corresponding set of promotion rules based on the transaction data and on the respective local retail data for the each of the plurality of retail points, and communicating to the at least one of the plurality of retail points the corresponding set of promotion rules. When the corresponding set of promotion rules, communicated to the at least one of the plurality of retail points, is applied to subsequent transaction data obtained at the at least one of the plurality′ of retail points, a resultant promotion is generated in response to application of the corresponding set of promotion rules to one or more of, for example, the subsequent transaction data, and/or to subsequent local retail data obtained at the at least one of the plurality of retail points.

Embodiments of the system may include at least some of the features described in the present disclosure, including at least some of the features described above in relation to the method, the server, and/or the computer readable media.

In some variations, a point-of-sale device is disclosed that includes one or more processor-based devices, and one or more memory storage devices to store instructions. The instructions, when executed on the one or more processor-based devices, cause operations including receiving from a central server a set of promotion rules, the central server is configured to receive information from a plurality of retail points that each includes at least one local computing device to facilitate transactions at the respective one of the plurality of retail points, the received information including transaction data for a plurality of transactions at one or more of the plurality of retail points and respective local retail data for each of the plurality of retail points, the server further configured to determine the set of promotion rules received by the point of sale device based on the transaction data and on the respective local retail data for the each of the plurality of retail points. The instructions cause further operations including applying the received set of promotion rules to subsequent transaction data obtained at the point of sale device to generate a resultant promotion in response to application of the received set of promotion rules to one or more of, for example, the subsequent transaction data, and/or to subsequent local retail data obtained at the at point-of-sale device.

Embodiments of the point-of-sale device may include at least some of the features described in the present disclosure, including at least some of the features described above in relation to the method, the server, the computer readable media, and/or the system, and may also include the following features.

The resultant promotion may include at least one second item to be presented to a customer at the point-of-sale device in response to applying the corresponding set of promotion rules to one or more of, for example, the subsequent transaction data, including information representative of at least one first item selected by the customer from a plurality of purchasable items available at the point-of-sale device, and/or the subsequent local retail data obtained at the point-of-sale device. The subsequent local retail data for the point-of-sale device may include one or more of for example, geographic location of the point-of-sale device, time information, date information, the plurality of purchasable items available at a retail point associated with the point-of-sale device, average time between transactions completed at the retail point associated with the point-of-sale device, and/or weather information at the retail point associated with the point-of-sale device.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein, “Substantially” as used herein when referring to a measurable value such as an amount, a temporal duration, a physical attribute (such as frequency), and the like, also encompasses variations of +20% or +10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of or” one or more of indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an example system configured to enable distributed processing of transaction data and determination of promotional content.

FIG. 2 is a schematic diagram of a generic POS device.

FIG. 3 is a flowchart of an example procedure to process transaction data and determine promotion content.

FIG. 4 is a schematic diagram of a generic computing system.

Like reference symbols in the various drawings indicate like elements.

### DETAILED DESCRIPTION

Disclosed herein are methods, systems, apparatus, devices, computer program products, media and other implementations, including a method that includes receiving at, a central computing system, information from a plurality of retail points (e.g., cash registers or point-of-sale devices deployed at one or more retail outlets) that each includes at least one local computing device to facilitate transactions at the respective one of the plurality of retail points, the received information including transaction data for a plurality of transactions at one or more of the plurality of retail points and respective local retail data for each of the plurality of retail points. The method further includes determining, at the central computing system, for at least one of the plurality of the retail points a corresponding set of promotion rules based on the transaction data and on the respective local retail data for the each of the plurality of retail points, and communicating to the at least one of the plurality of retail points the corresponding set of promotion rules. When the corresponding set of promotion rules that was communicated to the at least one of the plurality of retail points is applied to subsequent transaction data obtained at the at least one of the plurality of retail points, a resultant promotion is generated in response to application of the corresponding set of promotion rules to one or more of, for example, the subsequent transaction data, and/or to subsequent local retail data obtained at the at least one of the plurality of retail points. Examples of rules specified by the sets of promotion rules include an example rule specifying that if a customer buys a specific item then a list of three specific other items (which may be presented in in order of importance, potentially with a grade for each) is promoted, another example rule that if a transaction total is between a value X and a value Y then a list of three specific other items (which may be presented in order of importance, potentially with a grade for each), and a further example rule where if a transaction contains items of a particular group A (which may be associated with a plurality of different items) then some predetermined list of items (which may be presented in order of importance, potentially with a grade for each) is promoted. Many other types of rules may be implemented or specified via generated sets of promotion rules, and those rules may be specified/implemented using “if-then” rules, mapping functions, look-up tables, etc.

The systems, methods, and other implementations described herein, enable presenting promotions to customers (e.g., upsell or cross-sale offers, discounts, etc.) in response to real-time data (e.g., the last item scanned), such that a decision about the content of the promotion (e.g., which item to promote) is made within a short period of time within milliseconds of the receipt of the data upon which a decision is to be based). However, hardware display devices located at retail points that could be spanning a large geographical area may be relatively low-CPU-powered devices that may not be able to effectively and efficiently perform independently on-the-spot execution, updating and continuous improvement of the analytical engine needed to make decisions about promotional content to present. At the same time, while retail point devices can be connected to public and/or private networks (e.g., the Internet) to enable access to more powerful servers and/to a more complete and comprehensive data, retail points are often located in isolated geographic locales (remote gas stations) where the speed and reliability of network connections are not always suitable for the real-time data exchange between the retail point devices and a centralized server at which analytics can be performed.

As noted, the promotions presented to customers at retail point devices may include one or more upsell (cross-sale) items. In some embodiments, the promotions may also include promotional content such as activities that are presentable to, and performable by, customers, such as, for example, presenting lottery tickets or scratch cards (either on an interactive video display or on a printable medium such as paper) which provide chance (probability)-based outcomes. Outcomes of promotional activities may be associated with a reward(s), such that a favorable/successful chance-based outcome is achieved when, for example, at the conclusion of the activity, a customer's lottery ticket or scratch card is one that won the customer the associated reward. Further details about promotional chance-based activities that may be presented to customers are provided in U.S. patent application Ser. No. 13/938,468 (published as US 2014/0019220), entitled “SYSTEMS AND METHODS FOR DETERMINING AND PRESENTING ACTIVITIES WITH CHANCE-BASED OUTCOMES AND ASSOCIATED REWARD,” and filed Jul. 10, 2013, the content of which is hereby incorporated by reference in its entirety.

In the systems, method, and other implementations described herein, an arrangement is provided in which a process to determine promotional content is split (in location and time) between the two principal blocks of the system, namely:
A market intelligence/business intelligence (MI/BI) server that obtains data, performs necessary analytics, and generates sets of rule-based instructions (e.g., time-stamped XML-coded sets of rule-based instructions), referred to as playlists, that enable determination of the promotional content to be presented; and
Retail point devices a so referred to as the Delivery Stations (DS)) which include various types of point-of-sale (POS) devices, are configured to perform three main tasks. The first main task, generally performed in real-time or near real-time, is to execute current playlists. Executing playlists (executing promotion rules) does not require sophisticated analytics, particularly in embodiments in which the playlists are implemented as lookup tables. Such playlists may instruct a DS to display an informational slide at the bottom of the screen (e.g., weather forecast), to promote an “affinity” item (also referred to as an upsell or cross-sell item) where a person who buys product A would also be offered product B, and/or schedule price-book promotions (e.g., inform a customer about a two-for-one deal). A second principal task executed at a DS (which may be performed as a background task, i.e., not within a time-sensitive flow of a specific transaction) is to check for updated playlists, which may be received at the DS as a completely different playlist, or as an extended time-stamp on the current playlist. A third principal task executed by a DS is to collect data (such as local store information, time-stamped transaction data, data about outcomes of promotions, e.g., Whether a customer responded favorably to a particular promotion, etc.), and send the collected data (e.g., in batch mode) to the server.

In the systems, methods, and other implementations described herein, when the MI/BI server generates playlists for each specific delivery station it may take into account a substantial number (or, in some embodiments, an) of transaction data provided from the DS's deployed at retail points, and local or global data pertaining to one or more of the retails points and/or any of the DS's deployed at those retail points (including such local/global data as locations of retail points and/or of the DS's, time of day, date, weather conditions, inventory levels at the retail points where DS's are deployed, levels of activity at the retail points, etc.), thus resulting in potentially different playlists for each DS. For example, if at some location a customer scans a cup of coffee at 8:00 AM on a weekday, the playlist may, in response to this data, cause a promotional item of “banana” to be presented to the customer as a result of a rule in the playlist of that DS that was generated by the MI/BI server. The MI/BI may have generated that particular rule to reflect a learned pattern or behavior that enabled predicting (based, at least in part, on data indicating purchase of “coffee” and that the time of purchase is 8:00 AM) that the purchasing customer is a working individual heading up to the office and may wish to obtain a breakfast item. If, on the other hand, the same cup of coffee was scanned at 11:00 PM, then the playlist or a different playlist, corresponding to the current time of day) may include a promotional item of “5 hour energy” product in response to a rule (generated from learned behavior of the MI/BI server) that predicts that an individual purchasing coffee late at night is heading for a long drive e.g., if the prospective purchase of coffee is at a remote gas station), getting ready for an “all-nighter” at work or school, etc.

In the implementations described herein, the predictive determination of possible promotions to present is performed at the central MI/BI server, which results in the generation of playlists implementing the predictive determination of what promotion to present in response to data representative of local retail data and data indicating that a customer wishes to purchase a particular item. A DS at a particular retail point will then operate according to rules that result in different outcomes in response to different input data sets. For example, the DS may run a first in morning, that will cause a “banana” item to be promoted in response to data indicating that the customer wishes to buy coffee, and may run a different playlist at night that will cause a “5 hour energy” product to be promoted in response to the data indicating that the customer wishes to purchase coffee. With these implementations, the DS does not need to have a fast real-time connection to the server, but instead can execute simple rules that may updated at regular time intervals. In the implementations described herein, the analytics are performed substantially at the central server (e.g., the MI/BI server). It is to be noted that, in some embodiments, the items promoted may be items within “step-and-grab” reach so that a consumer could get an item that has been promoted without interrupting the transaction. In some embodiments, items being promoted that are not in the immediate vicinity of the DS may nevertheless be selected b r the customer through, for example, an “Add to Basket” feature that allows customers to prepay for the items promoted and to get the item after completion of the transaction from a shelf fridge not be within immediate reach from the DS.

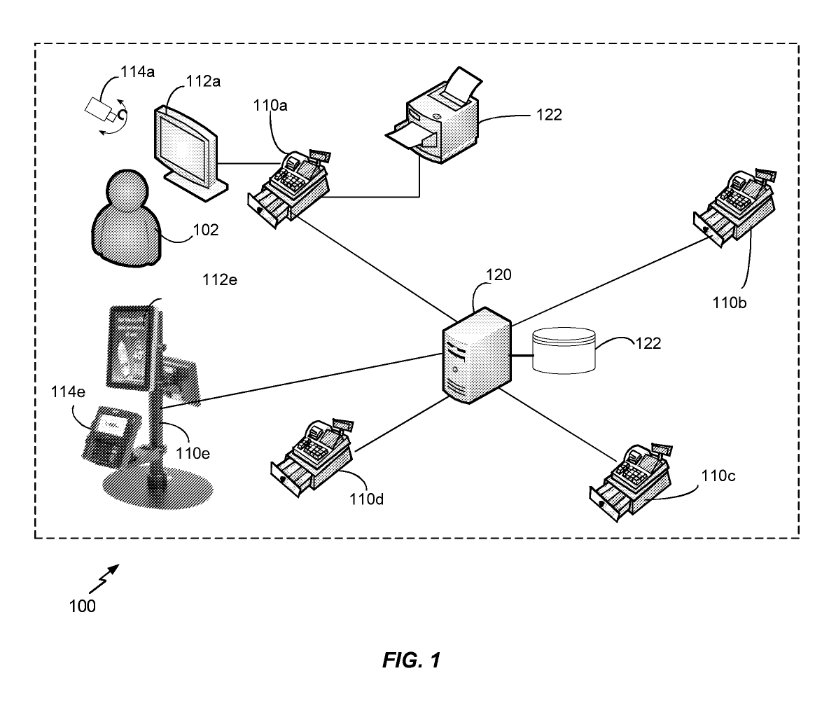

Thus, with reference to FIG. 1, a schematic diagram of a system 100 configured to enable distributed processing of transaction data at individual retail points, where devices with which users and consumers interface are deployed, in order to determine promotional content to present to the users/consumers, is shown. The system 100 includes one or more retail point devices (e.g., delivery stations) 110a-e at which a customer (such as a customer 102 shown in FIG. 1) may, for example, complete purchase transactions, obtain marketing information, etc. In some embodiments, one or more of the POS device, for example, the POS device 110a, may be an electronic cash register operable by an operator (e.g., in a fast-food joint, a supermarket, or some other retail outlet). In some embodiments, one or more of the POS devices may include, for example, a check-out point in which a user completes purchasing transactions without the assistance of a live operator by, for example, inputting information about an item or service it wishes to purchase through a suitable input-interface such as, for example, an optical scanner, a keyboard, a RFID sensing device, etc. In some embodiments, an image capture device, such as a camera (e.g., a security camera) 114a (deployed, in the example system 100 of FIG. 1, near the POS device 110a) may be used to capture images of items selected for purchase, and to identity based on the captured images the selected items and retrieve associated data (e.g., price, inventory levels, etc.) for the identified items. In some embodiments, one or more of the POS devices 110a-e may be a POS device such as the one described, for example, in U.S. patent application Ser. No. 11/314,713, entitled “SYSTEMS AND METHODS FOR AUTOMATIC CONTROL OF MARKETING ACTIONS”, and U.S. patent application Ser. No. 11/611,481, entitled “EXPOSURE-BASED SCHEDULING,” the contents of both of which are hereby incorporated by reference in their entireties.

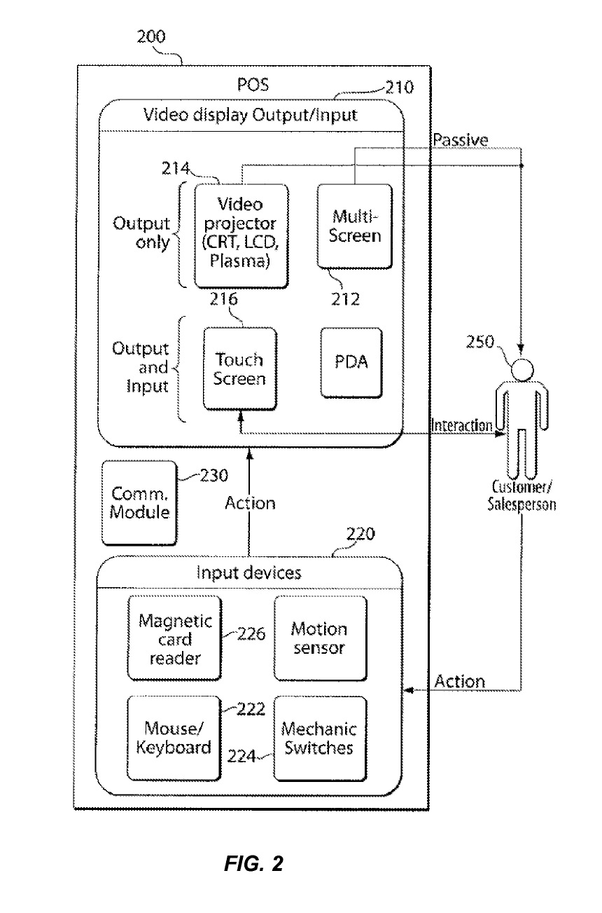

Particularly, with reference to FIG. 2, a schematic diagram of a generic POS device 200, which may be similar to one or more of the POS devices illustrated in FIG. 1, is shown. The POS device 200 includes an input/output display 210. The display 210 can include one or more of display devices such as a multi-screen device 212, and/or a video projector 214. Examples of suitable video projector devices that the display 210 may use include cathode-ray-tube based devices, liquid crystal display type devices, and/or plasma type display devices. Other types of display devices may be used. In some implementations, the display 210 may further include devices whose display surface is configured to receive input from a user 250 (such as a customer or a salesperson) interacting with the POS device 200. Thus, in some embodiments the display unit 210 may include a touch screen device 216 having a touch sensitive surface to enable users to enter data and/or make selections by directly touching areas of the screen as directed by audio prompts or graphical prompts presented on the screen. As further shown in FIG. 2, the POS device also includes input device unit 220. The input device unit may include one or more of the input devices depicted in FIG. 2 to enable the user 250 to enter data and make selections in a variety of ways. Thus, for example, the input device unit 220 may include a mouse/keyboard device 222, and/or mechanical switches unit 224. The input device unit 220 may include other types of data entry and/or data collection devices, including a magnetic and/or optical reader 226 (e.g., to swipe magnetic cards such as credit or debit cards).

Input collected at the POS device 200 (or by any of the other retail point device 110a-e depicted in FIG. 1) may be sent to a central computing system 120 for recordation and processing. Thus, each POS device may include a communication module 230, such as, for example, a transceiver, a network gateway, a wireless transceiver, etc., to transmit information collected or received at the POS 200 to a remote device, such as another POS device or a central server. Alternatively and/or additional, the collected data may be locally recorded and/or processed to generate resultant data at a processor-based device constituting part of the POS device collecting the customer's input. Information collected by POS device 200 may be first stored in local storage (e.g., volatile and non-volatile memory, not shown) of the POS device 200.

Turning back to FIG. 1, in some implementations, one or more of the retail point devices may be a tablet-based device, such as the tablet point-of-sale device 110e illustrated in FIG. 1. As shown, the retail point device 110e includes a tablet device 112e (e.g., which may include a processor-based device with a communication module to transmit and receive data wirelessly or via a direct physical connection to a network) to present promotions (e.g., local, in-store promotions) and interact with users (sales personnel, customers, etc.) The tablet-based retail point device 110e may further include a transaction processing device 114e which may be in communication with the tablet 112e and receive data therefrom. The transaction processing device 114e includes, in some embodiments, data acquisition module such as a magnetic card reader, an optical scanner, an image capturing device (such as a camera), etc., through which identity (and other data) for items selected for purchase by a customer/user can be obtained, and through which the customer user can provide electronic payment information (e.g., credit or debit card details indicating which account is to be charged when consummating the transaction). The tablet-based retail point device 110e, as well as the other retail point devices 110a-d depicted in FIG. 1, may be configured to determine promotional content, such as upsell (cross-sell) items to be offered to the customer who is completing a transaction, discounts, various activities (e.g., chance-based activities), etc., based on an analysis of current item data the customer is seeking to purchase, as well as on purchase history, price-book information, promotion schedule available at the particular retail point device, time, day, geographic location, weather conditions, and/or a myriad of other environmental variables. As will be described in greater detail below, in order to achieve real-time (or near real-time) response to the data received by a particular retail point device, a central server, such as a server 120 depicted in FIG. 1, generates sets of promotion rules for each of the various retail points and/or the various retail point devices in communication with the server 120, which can be directly applied at the local retail point devices to local data and transaction data obtained at those individual devices to determine promotional content to present to customers (e.g., upsell items).

As noted, the system 100 includes the central server 120 (e.g., a marketing intelligence/business intelligence, or MI/BI, server) in communication with the other stations/devices/nodes constituting the system 100, and may be configured to receive data from any of the stations/devices/nodes of the system to centrally process data. For example, the central server 120 may be configured to receive data from the various retail point devices 110a-e and/or or from other devices/nodes with which it is communicating, including transaction data for a plurality of transactions at one or more of the of retail points and respective local retail data for each of the retail points, and determine for the each of the retail points respective corresponding sets of promotion rules based on the transaction data and on the respective local retail data for the each of the of retail points. In some embodiments, the server 120 may also receive information from other systems e.g., backend systems, not shown, of a company operating all or a subset of the retail point devices communicating transaction information to the server 120). Such information may include, for example, data about inventory levels, and may be thus be used to further facilitate the processing of the transactions information to refine the predictive determination of promotional content (e.g., cross-sale offers) to be presented to customer at various retail point devices.

In some embodiments, the server 120 is configured to determine for at least one of the retail points (e.g., for a particular retail point device), based on the transaction data and on the respective local retail data for the each of the plurality of retail points, possible promotions presentable at the at least one of the plurality of retails points and based on respective associated likelihoods of customer acceptance for each of the possible promotions presentable at the at least one of the plurality of retail points. In such embodiments, the server 120 is also configured to generate the particular corresponding set of promotion rules based, at least in part, on the determined likelihoods of customer acceptance associated with the respective possible promotions presentable at the at least one of the plurality of retail points. For example, in some embodiments, promotional rules for a particular retail point may be generated based only on those possible promotions associated with likelihood of customer acceptance exceeding some predetermined threshold. In such embodiments, the possible promotions (for the particular retail point, or for a particular retail point device) whose respective associated likelihood of customer acceptance exceeds the predetermined threshold are identified, and are used to define rules that can be executed at the device of the particular retail point. In some embodiments, selection of those records of possible promotions that are used to generate promotion rules for a particular retail point (or a particular device) may be based on computed likelihoods that a customer purchased a promoted upsell item (or otherwise responded to the promotional content) because of the promotion (e.g., the likelihood associated with a particular promotion is derived from outcomes in which customers purchased a particular upsell item presented in a particular promotion as a result of the promotion, and not because the customers would have selected to purchase the particular upsell item with or without being presented with that promotion). Determination of these likelihood values (e.g., that a customer purchased an upsell item because of a promotion) may be performed by comparing the purchasing rate for customers who viewed the promotion versus the purchasing rate for customers who did not (e.g., performing a so-called “A/B test”).

In some embodiments, selection of the possible promotions that are used to generate promotion rules for a particular retail point (or retail point device) may be performed using optimization process(s) based on such metrics as expected revenue (derived from computations of a price*likelihood associated with a particular upsell item(s)), expected margin/profit (derived from computations of margin*likelihood associated with a particular upsell item(s)), etc.

The promotion rules that are generated based on the selected possible promotions may, in some embodiments, specify certain cross-sale promotions (and/or other types of promotional content) to be presented in response to specific corresponding purchasable items selected by a customer. For example, the generated rule set can specify the cross-sale/upsell item to be presented in response to a customer purchasing coffee, and specify the promotion of one or more items (e.g., gum) in response to some other input (e.g., when the customer selects soda, chips, or other items, for purchase). The promotion rules executed at a particular retail point (or retail point device) may cause the presentation of various promotions in response to different types of trigger data. Such trigger data may be particular item(s)/service(s) selected by a customer for purchase, and/or by various other triggers, such as the time, date, weather conditions, level of activity in a store, inventory levels, etc. In some embodiments, determination of the promotional content to present to a customer may be implemented using a nesting procedure. For example, a two-level prediction process may be implemented in which a first classification operation would determine it is best to promote, for example, a cold drink, while a second classification operation (i.e. the nested operation) would determine what type of cold drink is the best one to promote.

In some embodiments, to identify the set of possible promotions for a particular retail point (based on which a set of promotional rules can be generated), the server 120 maintains records of combinations of input data (e.g., previous transaction data for items that were initially chosen by customers, retail data including customers' particulars, data relevant to retail points such as location of retail points, weather condition, and so on) and corresponding promotional content (e.g., upsell items, rewards, and/or all other types of promotional content). Each combination (which may be stored in a central repository 122 in communication with the server 120) may be associated with a metric of likelihood of customer acceptance of the associated promotional content (that metric is also referred to as an effectiveness measure) that represents the probability that a customer will accept the upsell item(s), or otherwise respond to the promotional content that is presented, in response to the input data associated with promotional content for that combination. The combinations may also be associated with other data, such as confidence interval values representative of uncertainly associated with customer acceptance likelihoods.

In one example procedure, likelihoods of customer acceptance for possible promotions are derived based on a statistical model implemented using one or more machine-learning processes applied to the transaction data for the plurality of transactions at one or more of the plurality of retail points, and to the respective local retail data for the plurality of retail points. The goal of a statistical model is to predict the likelihood of a promotion being accepted (e.g., the likelihood of an upsell item, identified, for example, according to the item's Stock Keeping Unit, or SKU, being added to an order) based on a variety of available data. In some embodiments, the machine-learning procedures employed are configured to determine affinities between different items, e.g., which items are usually purchased together, along with related data such as when and/or where such purchases have taken place (e.g., coffee and banana being purchased together at 8:00 AM). This enables measuring the likelihood that a second, third, and/or additional items or services would be purchased by a customer who initially selected a first item or service that the customer wishes to purchase.

Some examples of machine-learning and classification procedures/models that may be implemented include the following:
Support Vector Machine (SVM)—An SVM generates functions from a set of labeled training data. The function can be a classification function (i.e., the output is binary) or the function can be a general regression function. When a support vector machine is used for classification applications, the support vector machine creates a hyperplane (or several hyperplanes) that separates data into two classes or more, if several hyperplanes are used) with maximum margins. When training examples that are labeled either yes or no are provided, a maximum-margin hyperplane splits the training examples such that the distance from the closest examples to the hyperplane may be maximized, thus resulting in a dividing hyperplane that is far as possible from the two divided sets of the training data. An advantage of SVM is that it enables the determination of a “certainty” or “likelihood” measure associated with the classification of a particular item of data. The determination of the likelihood measure may be based on the distance of the item of data from the dividing hyperplane. The closer the item of data is to the hyperplane, the lower the likelihood that the classification of that item of data is correct.
K-Nearest Neighbors (kNN)—A k-NN classifier is trained by inserting the training data points along with their labels into a spatial data structure, like an n-dimensional space (referred to as a “n-d-space”) used for organizing points/data in an n-dimensional space. In order to classify a data point, that a point's k nearest neighbors (using a predefined norm in Euclidean space) are found using the spatial data structure. The probability that the data point is of a particular class is determined by how many of the data point's neighbors are of that class and how far they are from each other.
Decision Tree—Another way to classify data points it to use a non-spatial tree called a decision tree. This tree is built by recursively splitting training data into groups on a particular dimension. The dimension and split points are chosen to minimize the entropy within each group. These decisions can also integrate some randomness, decreasing the quality of the tree but helping to prevent overtraining. After some minimum entropy is met, or a maximum depth hit, a branch terminates, storing in it the mix of labels in its group. To classify a new data point, the decision tree traverses the tree to find the new point's group (leaf node), and returns the stored mix,
Random Forest—One way to increase the accuracy of a classifier is to use a lot of different classifiers and combine the results. In a random forest, multiple decision trees are built using some randomness. When classifying a new data point, the results of all trees in the forest are weighted equally to produce a result.
Artificial Neural Network (ANN)—A neural network machine attempts to model biological brains by including logical neurons which are connected to each other with various weights. The weight values between connections can be varied, thus enabling the neural network to adapt (or learn) in response to training data it receives. In feed-forward neural nets, input values are supplied at one edge and propagate through a cycle-less network to the output nodes.
Tensor Density—this classifier discretizes the input space into different buckets. Each bucket contains the mix of classes in the training data set. A data point is classified by finding its bin and returning the stored mix. Generally, a tensor density classifier uses 0(1) lookup time, and is thus considered to be time-efficient.

In some embodiments, the classifiers may be implemented using regression techniques to derive best-fit curves, a classification procedure based on hidden Markov model, and/or other types of machine learning techniques/procedures. In embodiments in which a hidden Markov model-based classifier is used, patterns in the data being processed may be identified using self-similarity analysis, and the transitions in patterns may be used to build the hidden Markov model with which data is classified. In some embodiments, linear classification techniques like kernel methods which are capable of accurately classifying data but with reduced computational requirements may also be used.

Experimentation and testing of the implementations described herein have indicated that machine-learning/classification procedures/models can generally perform better at predicting item affinities then scoring-type models (regression, linear, logistic, etc.). In some embodiments, a machine learning/classification system may be implemented (e.g., at the central server 120 of the system 100) that uses a combination of support vector machines (SVM) and k-nearest-neighbor (k-NN) heuristics. SVM can partitions the multi-dimensional space of data into clusters (“neighborhoods”) with similar upsell likelihoods. To do so, the SVM procedure can transform the problem to a kernel space (possibly using non-linear transformations), where the different cases are separated from one another by maximizing the margin.

In some embodiments, a k-NN heuristic may be over-laid on top of the SVM to match “atypical” transactions on multiple dimensions that were not used/selected by the SVM. For example, an item that was not part of the dataset would be matched on category, price, and other available attributes to “nearest” existing transaction in the dataset (typically there are far more possible items that can be promoted than the number of items used for training of the particular machine-learning/classification procedures implemented). The parameters for the SVM and k-NN machine learning classification procedures implemented may be re-optimized daily based on the new data (transaction data and retail data related to local and global conditions) provided from retail point devices and other systems/nodes in communication with the central server 120.

Through experimentation and testing, the following information was determined to be useful to implement a statistical model that performed well in determining likelihoods of an item upsell: data relating to the last one of one or more items selected by a customer in a current transaction (e.g., the SKU of that last selected item, category of the item, item price, promotion status, etc.), total items selected by the customer in the current transaction (i.e., total number of items in the basket), total in-basket post-tax transaction value, average idle time between customers on current playlist used at the retail point at which the current transaction is taking place (this information can be considered as a proxy for how busy the retail point is), average and standard deviation of prices of items in the basket, imbalance between specific product groups (e.g., two coffees but only one doughnut), time-of-day, day-of-week, date/season, location (zip code), weather condition current and forecasted temperature/precipitation, and how that compares to the average for that time-date-location), etc. Weather information may be provided through various sources, including public information sources e.g., data provided through news servers), and also through data obtained locally at the retail points, e.g., via weather-type sensors (thermometers) and/or user-entered input. In some embodiments, the machine-learning classification implementation may also be configured to derive customer acceptance likelihoods based on such information as customer loyalty data (as determined from input data generated through customer loyalty cards).

While in the above-described example implementation and SVM and k-NN procedures are used in parallel to determine and predict customer acceptance likelihoods, other procedures, and/or other configurations of use (e.g., using the implemented procedures either in parallel or in some interdependent manner) may be used instead. The above-described SVM and k-NN example implementation was observed to provide good performance, possibly because non-parametric classification procedures are less sensitive to the lack of data density than regression-type models. The way different transactions are grouped by an SVM/k-NN implementation may be driven by the ability to better predict the likelihood of a successful promotion (e.g., likelihood of an upsell), and this may result in patterns that at first seem counter-intuitive. For example, stores A and B, which may be located across the street from each other (and intuitively may be deemed to be “in the same neighborhood”) may not have similar purchasing patterns. On the other hand, stores A and C, which are far apart from each other but on the same side of a route from a residential neighborhood to a business district, may have similar purchasing patterns because both intercept morning commute customers. The SVM/k-NN implementation can pick up on such similarities.

As noted, other machine-learning and classification procedures, and configurations of use may be used, including any one or more of, for example, neural networks, logistic regression techniques, various types of classification and regression trees, etc. Additionally, each of the SVM and k-NN procedures used in the above-described implementation may be used alone and independently to derive customer acceptance likelihoods.

In some embodiments, determination of likelihoods of customer acceptance for the promotional combinations maintained by the server 120 and the repository 122 may be performed according to the Wowing procedure. The customer acceptance likelihood (or effectiveness measure), p, and confidence interval associated with a particular combination may be computed based on the expression:

p=s/N,

where p is the likelihood that a promotion presented to a customer would be accepted by the customer, s represents a success score the number of times a particular promotion presented to a customers was met with success, and N is the number of times a particular promotion has been presented. The values p, s and N may be computed based on certain factors that are taken into account (e.g., s may be computed based on certain rules that define under what circumstances an outcome is to be deemed a success, and s may then be reduced by a success factor). A confidence interval, CI, representative of uncertainty associated with a derived likelihood of customer acceptance, may be computed according to the expression:

$$CI = z \cdot \sqrt{\frac{p \cdot ( 1 - p )}{n}}$$

where z represents the number of standard deviations to achieve a required significance (under the assumption of normal distribution). The z factor represents the probability that an actual value will be within the Cl. The higher the z factor, the higher that probability is. The required significance, under those circumstances, is computed as (1−z), i.e., the probability it is outside the CI. So if z−1, there is a 69% certainty that the value is within CI. A value of z=1 may be used because the purpose of the confidence interval is to be a comparative measure for different estimate values, thus multiplying it by any constant is generally not required. It is to be noted that z=1 corresponds to statistical significance of about 31%, z=2 corresponds to 5%, and z=3 corresponds to 1%.

To compute an updated likelihood of acceptance (effectiveness measure) and confidence interval for a particular promotion, an adjusted value of N is determined using the relationship:

N_{old}=p_{old}*(1−p_{old})/confidence_{old}²

The updated effectiveness measure may thus be computed according to:

p_{updated}=(p_{old}*N_{old}+p_{measured}*Nₚ)/(N_{old}+Nₚ),

where p_{measured} corresponds to the effectiveness measure computed for the current interval alone (i.e., without factoring in the old effectiveness measure and/or the old confidence interval). Under circumstances where the particular promotion was not presented in any promotion in the most recent interval, the updated effectiveness measure is simply computed to be p_{old}.

The updated value for the confidence interval may be computed according to the expression:

$${CI}_{updated} = \sqrt{\frac{p \cdot ( 1 - p )}{{N}_{old} + {N}_{p}}}$$

where Nₚ is the number of times in Which the particular reward and/or activity, associated with particular input data, has been offered in the current period (i.e., since the last time that the effectiveness measure and confidence interval for that particular reward and/or activity have been computed).

It should be noted that the initial values for the effectiveness measures and confidence intervals for any reward and/or chance-based activity, presented in response to input data (e.g., items purchased by a customer, particulars of the customer, etc.) may be set, for example, to an effectiveness measure of 0 with a confidence interval of 1. Other initial values may be used.

To illustrate the procedure to update selection parameters (e.g., effectiveness measure, confidence interval, etc.) for a particular promotion (e.g., an upsell item, a discount on some particular item or service, a free item, redeemable points, a chance-based activity, etc.), consider an example in which a particular promotion A is associated with an effectiveness measure (likelihood of acceptance) of, for example, 2.5% that was previously computed based on a success score of 5 (e.g., five successful promotions) resulting from 200 promotions involving the promotion A. The current confidence interval for the reward A is computed as Cl_{A}=\sqrt{0.025*(1−0.025)/200}=0.011 ers are subsequently used in the selection process to determine, for example, an upsell promotion (or some other promotional content) to present to a customer in response to customer-related input data.

When these parameters are to be updated (e.g., at the end of some pre-determined period), the sum of successful offers resulting from N number of promotions following the most recent update (which resulted in the current effectiveness measure 0.025 and a confidence interval of 0.011) will be used to compute the updated parameters. Suppose that in the above example, over the subsequent pre-determined period (e.g., a week) the promotion A was promoted 250 times, and those promotions resulted in 10 successful promotion acceptances. Thus, during the current period, Nₚ, is 250 and the new effectiveness measure, p_{measured}, is 10/250=0.04

Suppose also that the old confidence interval associated with the promotion A was modified daily to reflect the increasing uncertainty of the validity of the aging parameters; and that by week's end the old confidence interval for the promotion A was modified from its initial 0.011 value to 0.012 (in some embodiments, this modification may occur at set intervals based on some pre-determined function). Accordingly, to update the old parameter values of the effectiveness measure and the confidence interval, an adjusted value N that corresponds to the effectiveness measure of 0.025 and the modified confidence interval of 0.012 is computed according to:

N=p(1−p)Cl²,

where p is the effectiveness measure representative of the likelihood that a customer would accept the promotion A in response to the input data related to that customer (e.g., the customer's purchase of certain goods, particulars relating to the customer, local data relating to the retail point where the customer is located, etc.) Plugging in the values of p=0.025 and CI=0.012, the corresponding adjusted value of N is computed to be approximately 169 samples.

With that computed adjusted value of N corresponding to the periodically modified old confidence interval value, the updated effectiveness measure and updated confidence interval are computed according to the Equations:

$${p}_{updated} = ( {p}_{old} * {N}_{old} + {p}_{measured} * {N}_{p} ) / ( {N}_{old} + {N}_{p} )$$

$$and$$

$${CI}_{updated} = \sqrt{\frac{p \cdot ( 1 - p )}{{N}_{old} + {N}_{p}}}$$

to yield the values of p_{updated}=0.034, and CI_{updated}=sqrt(0.034*(1−0.034)/(169+250)=0.0088.

In the above computation, factors, such as randomness success factor (RSF), were not taken into account. However, in some implementation, the RSF, as well as other factors, may be taken into account to compute the selection parameters such as the effectiveness measure and/or the confidence interval.

Further details regarding implementations of procedures that could be used to determine promotions to present to customers are described in U.S. application Ser. No. 12/697,867 (issued as U.S. Pat. No. 8,321,276), entitled “PROCESSING OF COMMERCE-BASED ACTIVITIES”, and filed Feb. 1, 2010, the content of which is hereby incorporated by reference in its entirety.

Thus, in some embodiments, determining the possible promotions and the respective associated likelihoods of customer acceptance for each of the possible promotions may include determining, for each of the possible promotions, at least one second item to be presented to a customer at the at least one of the plurality of retail points in combination with at least one first item, selected by the customer from a plurality of purchasable items available at the at least one one of the plurality of retail points, based, at least in part, on effective measures that are each associated with at least one combination from a set of combinations that each includes the at least one first item to be purchased and a corresponding offer of cross-sale of at least one other item from the plurality of purchasable items available at the at least one one of the plurality of retail points, with each of the effectiveness measures being representative of a likelihood that the at least one other item to be offered to the customer would be accepted when offered in combination with the at least one first item being purchased. The effective measure (likelihood of customer acceptance) may be computed based on p=s/N, where p represents the likelihood of the cross sale of the respective at least one other item when offered in combination with the respective at least one first item, s represents a number of successful cross sales over a period of time for the respective at least one other item when offered in combination with the respective at least one first item, and N is the number of times a cross-sale promotion offering the respective at least one other item in combination with the respective at least one first item has been presented over the period of time.

Based on the records of possible promotions (which include associated customer acceptance likelihoods derived via machine-learning and classification procedures, and/or iterative computations of such likelihoods/effective measures as described herein) a subset of possible promotions, based on which a set of rules to be executed at a retails point can be generated, is identified (this process is referred to as optimization). As noted, in some embodiments, the subset of possible promotion that is used to generate a set of rules to be executed at a retail point (and/or device) may be selected based on likelihoods that a customer will select an associated upsell item(s), or otherwise respond to an associated promotional content, because of the promotion. As also noted, selection of the subset of possible promotion may be performed through filtering based on predetermined likelihood thresholds values, based on optimization on such metrics as expected revenues, expected margin/profits, etc., computed from the records of possible promotions, etc.

In some embodiments, the MI/BI server 120 is configured to loop through some or all combinations associated with specified input predictors (such as location or time), and for each combination that changes in real time e.g., a most commonly selected item, such as “coffee”) to loop again through all possible cross-sale upsell items (e.g., “banana”, “muffin”). Thus, if there are multiple parameters or various items associated with a particular promotion, the server may need to go over all possible combinations to determine what their outcome in real time might be. A random draw from such item's predicted distribution of likelihoods of being added to an order may then be taken (referred to as the “score”). The smallest size set of upsell items whose corresponding aggregate score (i.e., probability of an upsell) is above a pre-determined threshold (e.g., 50%) may then be selected. The selected set of items can then be included into a playlist (i.e., a set of promotion rules), which, in some embodiments, may be generated as WI, code of “what-if” logic such that if a delivery station (DS) executing the playlist receives data representative of a given transaction (e.g., “coffee” scanned) associated with a particular set of upsell items identified in the playlist, then the DS will promote an item from that particular set of upsell items (e.g., if a transaction contains items of a particular group A, then promote some predetermined item(s). The item the DS chooses to promote may be selected randomly with all specified upsell items in the particular set having an equal probability of being selected, or with the probability of being selected being proportional to the item's score, expected revenue, expect margin, etc.

An advantage of an implementation in which randomly drawn scores are used (as opposed to, for example, point estimates only) is that the system can more frequently promote items about which it is less certain. For example, an item with a 10% likelihood of purchase but with a 40% standard deviation may be promoted even if there exists another item with a 50% likelihood of purchase, but only 10% standard deviation, because the random draw from a (10/40) distribution may by chance exceed a draw from the (50/10) distribution. A “randomly-drawn-score” implementation is more conducive to learning.

In some embodiments, selection of the possible promotion records is performed by identifying those records (which may be maintained in the repository 122 and managed by the server 120 of FIG. 1) that are associated with a particular set of parameters (e.g., records corresponding to one or more of a particular retail point, a particular time of day, a particular day, particular weather conditions, etc.) As noted, in some embodiments, records, for a particular set of parameters corresponding to a retail profile (one or more retails points, certain weather conditions, time information, etc.) that are associated with a customer acceptance likelihood exceeding some predetermined threshold may be identified and selected from the repository 122. The identified records are used to define a set of rules (e.g., “if-then” rules, mapping rules, look-up tables, etc.) to map subsequent inputs that may be received at the particular retail point to a limited set of promotional content.

By generating customized sets of rules for different retail points and/or different factors/parameters, the process of selecting at different distributed retail points appropriate promotional content is simplified, while still enabling different promotional content specific to different locations and/or conditions to be achieved.

There are several points worth noting about the optimization processes described herein. An important part in the development and implementation an optimization model is to identify the objective of the optimization. A natural choice is to implement a system that would maximize the incremental margin (profit) from promotions (often referred to as “lift”). This requires the data on prices of items (which may be available in a price-book) and their costs. After surveying the operations of some retail operations as well as convenience store chains, it was discovered that typically, there is often no practical way to assess the exact unit cost of each item (as identified, for example, by an SKU). This happens because the majority of SKIN are supplied by multi-item (and often multi-category) vendors, and thus the delivery charges, slotting fees, bonuses for achieving brand/category/manufacturer sales targets, and all other payments and costs levied for groups items, are not typically allocated down to individual SKUs. As a result, in some embodiments, the example systems, methods, and other implementations described herein were realized to achieve a revenue maximization objective (but, as noted, other implementation objectives may be used in some embodiments). It should also be noted that even the price-book information may not be up-to-the-minute accurately recorded at any centralized location that the MI/BI server (such as the server 120 of FIG. 1) can access. Price-book information may be location-specific, but often requires a manual override to come into effect at cash registers. That is, in some embodiments, the price-book information is sent to the in-store PC from the C-store central systems, but then a user or operator (e.g., the store manager) would “push” that update to the local cash registers. Since the promotion displays (that are determined by the MI/BI server) should not differ from the price-book information at the cash-register (and, in fact, often may not differ due to legal requirements that actual sale prices not exceed promotional prices), the actual revenue optimization is performed at the DS. For example, a retail point device (such as a DS) can tap into the cash-register for the current price-book information, compute expected revenue from promoting items, and prioritizes what upsell items to display so that a probability of displaying an item is proportional to its expected revenue.

Another point worth noting is that one concern is the trade-off between learning and optimization. The more items that are selected for purchase by a customer, the more information the system has to consider in order to determine the right item(s) to promote, but with fewer opportunities to promote them. In contrast, after a first selected item is scanned, the system has the most promotion opportunities to promote upsell, but has the least amount of data to determine which items to promote.

A further point worth noting is that there are several kinds of promotions (e.g., nation-wide manufacturer-run promotions, new product introductions, and the statistical model analysis promotions described herein) that may be implemented concomitantly. Additionally, there are several other uses for the retail point devices (the DS's) beyond promotions of items in response to items selected by the customer. For example, a separate mechanism may be implemented to display items while the customer is paying for the transaction, e.g. presenting savings information relating to a possible subsequent visit, loyalty incentive information, and/or survey information (e.g., customer satisfaction, customer opinions regarding new product offering, etc.)

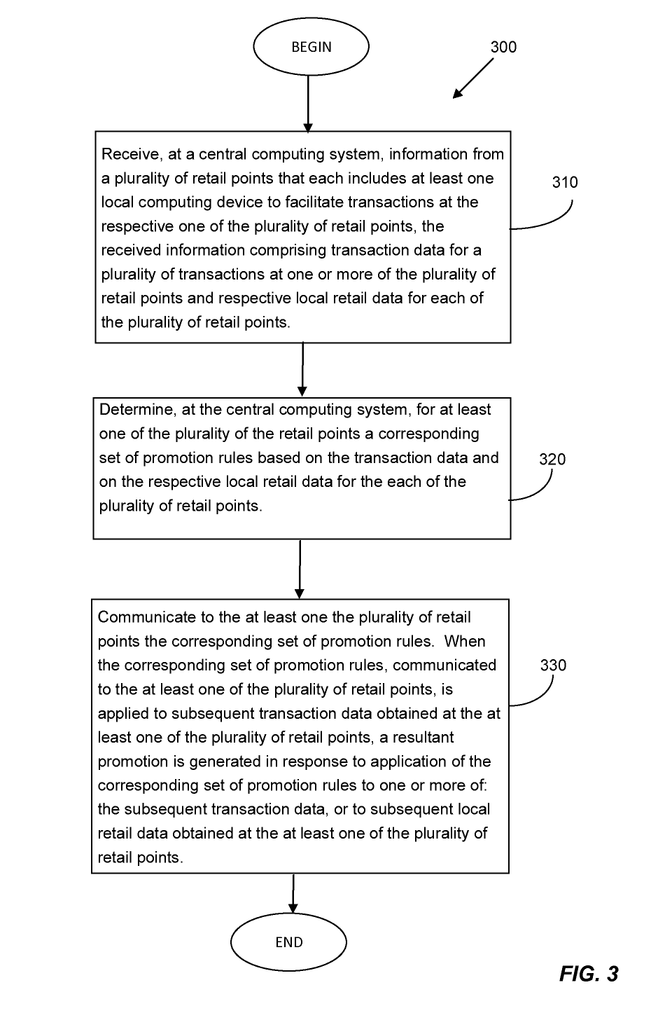

With reference now to FIG. 3, a flowchart of an example procedure 300 to process transaction data and determine promotion content (e.g., promotion rules) is shown. The procedure 300 includes receiving 310, at a central computing system (such as the MI/BI server 120 depicted in FIG. 1), information from a plurality of retail points that each includes at least one local computing device (such as any of the devices 110a-e illustrated in NG. 1, or the device 200 shown in FIG. 2) to facilitate transactions at the respective one of the plurality of retail points. The received information includes transaction data for a plurality of transactions at one or more of the plurality of retail points and respective local retail data (e.g., geographical location of the retail points, weather conditions, customer activity levels, etc.) for each of the plurality of retail points.

Based on the transaction data and on the respective local retail data for the each of the plurality of retail points, a determination is made 320, at the central computing system, for at least one of the plurality of the retail points, for a corresponding set of promotion rules. For example, as described herein, in some embodiments, determination of promotion rules is performed, in some embodiments, by compiling, from transaction and retail data, records of possible promotions that could be presented at one or more of the computing devices at the retail points, with the possible promotions records each associated with customer acceptance likelihoods (representative of likelihood that a customer would favorably respond to the associated promotion) derived via machine-learning/classification procedures, and/or through iterative computation of such likelihoods. A subset of possible promotion records may then be selected throne or more retail points at which those promotions are to be presented (based on information specific to the retail points at which the promotions are to be presented, based on the customer acceptance likelihoods associated with the promotions considered, etc.) Based on the selected subset of possible promotion, a set of promotion rules for the particular one or more retail points is generated. The set of promotion rules may be represented using “if-then” statements, mapping functions, lookup tables, etc., to enable determination of which promotion(s) to present in response to particular input data (e.g., subsequent transaction data and/or subsequent retail data) received at a computing device at the particular retail point(s) applying the rules in the set of promotion rules.

The generated set of promotion rules is communicated 320 to the at least one of the plurality of retail points.

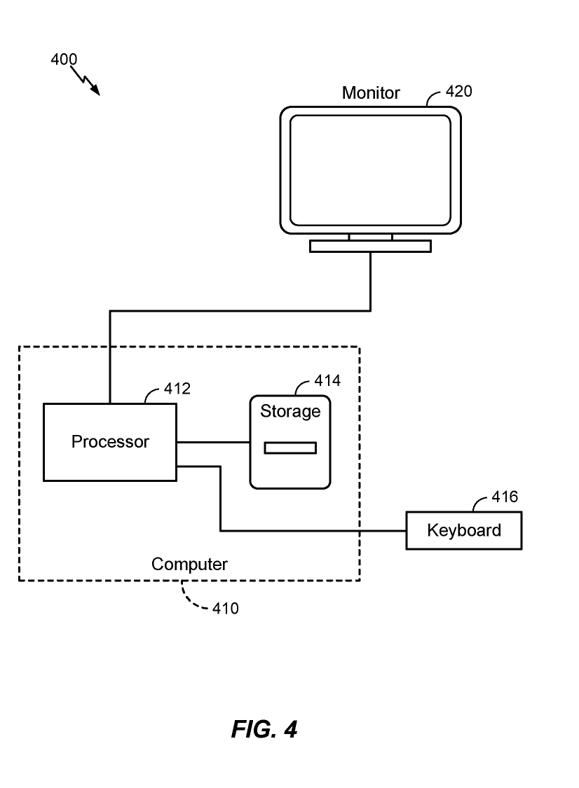

Performing the various operations described herein may be facilitated by a processor-based computing system. Particularly, at least some of the various systems/devices described herein (e.g., any of the devices 110a-e or the server 120 depicted in FIG. 1) may be implemented using one or more processing-based devices. Thus, with reference to FIG. 4, a schematic diagram of a generic computing system 400 is shown. The computing system 400 includes a processor-based device (or some other type of controller device) 410 such as a personal computer, a specialized computing device, and so forth, that typically includes a central processor unit 412. In addition to the CPU 412, the system includes main memory, cache memory and bus interface circuits not shown). The processor-based device 410 may include a mass storage element 414, such as a hard drive or flash drive associated with the computer system. The computing system 400 may further include a keyboard 416, or keypad, or some other user input interface, and a monitor 420, e.g., a CRT (cathode ray tube) or LCD (liquid crystal display) monitor, that may be placed where a user can access them.

The processor-based device 410 is configured to facilitate, for example, the implementation of operations to process transaction data from distributed retail point devices (e.g., in order to determine possible promotions that can be presented at various retail points, and determine customer acceptance likelihoods associated with the possible promotions information), to determine from the possible promotion records sets of promotion rules that can be applied at the various retail points, to apply the sets of promotion rules and present promotional content, etc. The processor-based device may also be configured to perform other general computer-based operations. The storage device 414 may thus include a computer program product that when executed on the processor-based device 410 causes the processor-based device to perform operations to facilitate the implementation of the above-described procedures. The processor-based device may further include peripheral devices to enable input/output functionality. Such peripheral devices may include, for example, a CD-ROM drive and/or flash drive (e.g., a removable flash drive), a network connection (e.g., implemented using a USB port and/or a wireless transceiver), for downloading related content to the connected system. Such peripheral devices may also be used for downloading software containing computer instructions to enable general operation of the respective system/device. Alternatively, and/or additionally, in some embodiments, special purpose logic circuitry, e.g., an FPGA (field programmable gate array), an ASIC (application-specific integrated circuit), a DSP processor, etc., may be used in the implementation of the system 400. Other modules that may be included with the processor-based device 410 are speakers, a sound card, a pointing device, e.g., a mouse or a trackball, by which the user can provide input to the computing system 400. The processor-based device 410 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Some or all of the subject matter described herein may be implemented in a computing system that includes aback-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed:

1. A system for processing transaction data from a plurality of gas stations comprising:
a plurality of point of sale (POS) devices each comprising:
a processor;
an input device configured to receive user input indicative of selected items; and
a memory configured to store computer program code configured to, with the processor, cause the POS device to:
receive an indication of at least one selected item from the input device; and
automatically generate transaction data indicative of the at least one selected item and local retail data;
a market intelligence (MI) server comprising:
a server processor; and
a server memory configured to store server computer program code configured to, with the server processor, cause the MI server to:
receive, in real time, transaction data from the plurality of POS devices indicative of at least one selected item and local retail data from each of the plurality of POS devices;
determine for at least one of the plurality of POS devices a set of promotion rules based on the at least one selected item and the local retail data from each of the plurality of POS devices; and
communicate, in real time, the set of promotion rules to the at least one of the plurality of POS devices,
wherein when the set of promotion rules is applied to subsequent transaction data received at the at least one of the plurality POS devices, and a promotion is generated in response to application of the set of promotion rules to one or more of the subsequent transaction data or subsequent local retail data obtained at the at least one of the plurality of POS devices, and
wherein at least one of the plurality of POS devices is remotely located from other POS devices of the plurality of POS devices and the MI server.

2. The system of claim 1, wherein the promotion comprises at least one second item to be presented to a customer at the at least one of the plurality of POS devices in response to applying the set of promotion rules to one or more of the subsequent transaction data, including information representative of at least one first item selected by the customer from a plurality of purchasable items available at a retail point associated with the at least one of the plurality of POS devices or the subsequent local retail data obtained at the at least one of the plurality of POS devices.

3. The system of claim 2, wherein the subsequent local retail data for the at least one of the plurality of POS devices comprises one or more of a geographic location of the at least one of the plurality of POS devices, time information, date information, the plurality of purchasable items available at a retail point associated with the at least one of the plurality of POS devices, average time between transactions completed at the at least one of the plurality of POS devices, or weather information at the at least one of the plurality of POS devices.

4. The system of claim 2, wherein the subsequent transaction data comprises one or more of an identity of the at least one first item selected by the customer, a price of the at least one item selected by the customer, a computed average and standard deviation for the price of the at least one items selected by the customer, or a time at which the at least one first item was selected by the customer.

5. The system of claim 1, wherein the sever memory and server computer program code are further configured to, with the server processor, cause the MI server to:
determine for the at least one of the plurality of the POS devices the set of promotion rules comprises:
determine possible promotions presentable at the at least one of the plurality of POS devices and likelihood values for customer acceptance associated with each of the possible promotions based on the transaction data and on the respective local retail data for the each of the plurality of POS devices; and
generate the set of promotion rules based, at least in part, on the determined likelihood values of customer acceptance associated with each of the possible promotions.

6. The system of claim 5, wherein the sever memory and server computer program code are further configured to, with the server processor, cause the MD server to:
generate the set of promotional rules based on one or more metrics derived based on the determined likelihood values, wherein the one or more metrics include an expected revenue or an expected margin for each of the possible promotions.

7. The system of claim 5, wherein the sever memory and server computer program code are further configured to, with the server processor, cause the MI server to:
determine, for each of the possible promotions, at least one second item to be presented to a customer at the at least one of the plurality of POS devices in combination with at least one first item selected by the customer from a plurality of purchasable items available at a retail point associated with the at least one of the plurality of POS device, based, at least in part, on effectiveness measures that are each associated with at least one combination from a set of combinations that each includes the at least one first item to be purchased and a corresponding offer of cross-sale of at least one other item from the plurality of purchasable items available at the retail point associated with the at least one of the plurality of POS devices, each of the effectiveness measures being representative of a likelihood value that the at least one other item to be offered to the customer would be accepted when offered in combination with the at least one first item being purchased, and computed based on p=s/N, where p represents the likelihood value of the cross sale of the at least one other item when offered in combination with the at least one first item, s represents a number of successful cross sales over a period of time for the at least one other item when offered in combination with the at least one first item, and N is the number of times a cross-sale promotion offering the at least one other item in combination with the at least one first item has been presented over the period of time.

8. The system of claim 5, wherein the sever memory and server computer program code are further configured to, with the server processor, cause the MI server to:
derive the likelihood values for customer acceptance for each of the possible promotions based on a statistical model implemented using one or more machine-learning processes applied to the transaction data for a plurality of ‘transactions at the at least one of the plurality of POS devices and the local retail data for each of the plurality of POS devices.

9. The system of claim 8, wherein the sever memory’ and server computer program code are further configured to, with the server processor, cause the MI server to:
derive the likelihood values based on a statistical model generated using a support vector machine process used in conjunction with a k-nearest neighbors process applied to the transaction data for the plurality of transactions at the at least one of the plurality of POS devices and the local retail data for each of the plurality of POS devices.

10. The system of claim 8, wherein the one or more machine learning processes comprise one or more of a support vector machine, a k-nearest neighbor procedure, a decision tree procedure, a random forest procedure, an artificial neural network procedure, a tensor density procedure, a regression technique, or a hidden Markov model procedure.

11. The system of claim 5, wherein the sever memory and server computer program code are further configured to, with the server processor, cause the MI server to:
receive, from the at least one of the plurality of POS devices, data representative of outcomes associated with promotions presented at the at least one of the plurality of POS devices over a pre-determined period of time.

12. The system of claim 1, wherein the sever memory and server computer program code are further configured to, with the server processor, cause the MI server to:
communicate a plurality of sets of promotional rules to the at least one of the plurality of POS devices, wherein each of the plurality of sets of promotional rules is associated with a respective time period during which the associated one of the plurality of sets of promotional rules is applied at the at least one of the plurality of POS devices.

13. A market intelligence (MI) server for processing transaction data from a plurality of gas stations comprising:
a server processor; and
a server memory configured to store server computer program code configured to, with the server processor, cause the MI server to:
receive, in real time, transaction data from a plurality of POS devices, wherein the transaction data is indicative of the at least one selected item and local retail data from each POS device of the plurality of POS devices, wherein the at least one selected item is based on user input received from an input device associated with a respective POS device;
determine for at least one of the plurality of POS devices a set of promotion rules based on the at least one selected item and the local retail data from each of the plurality of POS devices; and
communicate, in real time, the set of promotion rules to the at least one of the plurality of POS devices,
wherein when the set of promotion rules is applied to subsequent transaction data received at the at least one of the plurality POS devices, and a promotion is generated in response to application of the set of promotion rules to one or more of the subsequent transaction data or subsequent local retail data obtained at the at least one of the plurality of POS devices, and
wherein at least one of the plurality of POS devices is remotely located from other POS devices of the plurality of POS devices and the MI server.

14. The system of claim 13, wherein the promotion comprises at least one second item to be presented to a customer at the at least one of the plurality of POS devices in response to applying the set of promotion rules to one or more of the subsequent transaction data, including information representative of at least one first item selected by the customer from a plurality of purchasable items available at a retail point associated with the at least one of the plurality of POS devices or the subsequent local retail data obtained at the at least one of the plurality of POS devices.

15. The system of claim 14, wherein the subsequent local retail data for the at least one of the plurality of POS devices comprises one or more of a geographic location of the at least one of the plurality of POS devices, time information, date information, the plurality of purchasable items available a retail point associated with at the at least one of the plurality of POS devices, average time between transactions completed at the at least one of the plurality of POS devices, or weather information at the at least one of the plurality of POS devices.

16. The system of claim 14, wherein the subsequent transaction data comprises one or more of an identity of the at least one first item selected by the customer, a price of the at least one item selected by the customer, a computed average and standard deviation for the price of the at least one items selected by the customer, or a time at which the at least one first item was selected by the customer.

17. The system of claim 13, wherein the sever memory and server computer program code are further configured to, with the server processor, cause the MI server to:
determine for the at least one of the plurality of the POS devices the set of promotion rules comprises:
determine possible promotions presentable at the at least one of the plurality of POS devices and likelihood values for customer acceptance associated with each of the possible promotions based on the transaction data and on the respective local retail data for the each of the plurality of POS devices; and
generate the set of promotion rules based, at least in part, on the determined likelihood values of customer acceptance associated with each of the possible promotions.

18. The system of claim 10, wherein the sever memory and server computer program code are further configured to, with the server processor, cause the MI server to:
generate the set of promotional rules based on one or more metrics derived based on the determined likelihood values, wherein the one or more metrics include an expected revenue or an expected margin for each of the possible promotions.

19. The system of claim 10, wherein the sever memory and server computer program code are further configured to, with the server processor, cause the MI server to:
determine, for each of the possible promotions, at least one second item to be presented to a customer at the at least one of the plurality of POS devices in combination with at least one first item selected by the customer from a plurality of purchasable items available at a retail point associated with the at least one of the plurality of POS device, based, at least in part, on effectiveness measures that are each associated with at least one combination from a set of combinations that each includes the at least one first item to be purchased and a corresponding offer of cross-sale of at least one other item from the plurality of purchasable items available at the retail point associated with the at least one of the plurality of POS devices, each of the effectiveness measures being representative of a likelihood value that the at least one other item to be offered to the customer would be accepted when offered in combination with the at least one first item being purchased, and computed based on p=s/N, where p represents the likelihood value of the cross sale of the at least one other item when offered in combination with the at least one first item, s represents a number of successful cross sales over a period of time for the at least one other item when offered in combination with the at least one first item, and N is the number of times a cross-sale promotion offering the at least one other item in combination with the at least one first item has been presented over the period of time.

20. The system of claim 10, wherein the sever memory and server computer program code are further configured to, with the server processor, cause the MI server to:
derive the likelihood values for customer acceptance for each of the possible promotions based on a statistical model implemented using one or more machine-learning processes applied to the transaction data for a plurality of transactions at the at least one of the plurality of POS devices and the local retail data for each of the plurality of POS devices.
